(19) United States
(12) Patent Application Publication
(10) Pub. No.: US 2017/0037833 A1
(43) Pub. Date: Feb. 9, 2017

(54) Device for production of a net impulse by precession

(71) Applicant: Daniel Panico, Jashua Tree, CA (US)

(72) Inventor: Daniel Panico, Jashua Tree, CA (US)

(21) Appl. No.: 14/999,720

(22) Filed: Jun. 16, 2016

Related U.S. Application Data
(60) Provisional application No. 62/230,847, filed on Jun. 16, 2015.

(51) Int. Cl. F03G 3/00; H02N 11/00; F03G 7/10

(52) U.S. Cl. CPC F03G 3/00; F03G 7/10; H02N 11/006; F03G 2730/07; Y10S 74/09

(57) ABSTRACT

One embodiment of a device for producing a net unbalanced propulsive force has several wheels 24 rolling on a circular track 26 and angled to the plane of the track, such that every element of the wheels describes a repeating angled arcuate path. Precession of each “half-wheel” thus operating produces an unbalanced force normal to the plane of the wheel, with two components: 1) one that cancels all around with those of the other wheels, and 2)one that adds to produce a propelling force normal to the plane of the track.

Other embodiments are described and shown.

### CROSS-REFERENCE TO RELATED APPLICATIONS

This application claims the benefit of provisional patent application, No. 62/230,847, filed 2015 Jun. 16 by the present inventor.

### BACKGROUND

Devices which propel themselves forward without pushing against anything outside themselves or ejecting propellant have been tried in the past without much success. The device described here is simple, straightforward and theoretically sound. It uses precession of spinning “half-wheels” to propel itself forward. The “equal and opposite” reaction is against the frame itself.

### SUMMARY

This device causes a mass to move in a series of arcs that follow a larger circle, and whose planes are angled away from that of the circle and not perpendicular to it. The resulting precession causes a net force or impulse normal to the plane of the circle, which drives the device forward.

### Construction of First Embodiment

In FIGS. 1A and 1B, a motor 10 is attached to a base plate 12. A cone 14 of sheet metal or other material, with cut-outs 16 for cooling of motor 10, is attached to base plate 12 and to motor 10. The angle of the cone wall to the base plate all around is about 45 degrees, although other angles would work to some degree. A disc 18 of some thickness is attached to motor shaft 20. Arms 22 are rigidly attached to disc 18 and extend out and down from disc 18 at the same angle as that of the cone-base plate angle. Arms 22 may be steel rod and are fairly rigid. Wheels 24 are attached rotatably to the ends of arms 22 and ride square on cone 14. Wheels 24 are somewhat smaller than track 26 on which they ride (shown by dotted line). They may be ½, ¼, ⅛, the size of track 26 (by diameter) and weighted in the rim. 2-12 or more wheels may be used, but 4 is considered an effective number. FIG. 1A shows only two wheels 24. Rollers, conical or straight, may be used instead of wheels.

### Operation of First Embodiment

The position of disc 18 on motor shaft 20 is adjusted to press wheels 24 fairly hard against cone 14. Motor 10 is energized and, by way of disc 18 and arms 22, rolls wheels 24 around cone 14. Precession acts on wheels 24 in an unbalanced manner to drive the device in one direction, in this case “downward” as shown by arrow A.

To cancel motor torque, two similar devices may be used side-by-side, in tandem, or back-to-back with motors turning in opposite directions. The force of precession occurs in the same direction whether the motor turns clockwise or counterclockwise.

### Explanation of Operation of First Embodiment

(The figures are shaded for clarity.) In regular precession, a freely-spinning wheel (FIG. 2A) held by its axle and turned right-to-left (FIG. 2B) will react by turning top-to-bottom (FIG. 2C). This reaction is a torque or coupled force tending to twist the wheel-axle assembly.

In a rolling wheel (FIG. 3A), each element 28 or bit of mass of the wheel 24 takes a path which is a series of arcs 30 or “semi-circles” which can be considered “half-wheels” as far as precession is concerned. (The changing position of element 28 is shown by “pointers” on rolling wheel). In this device, the “half-wheels” are constantly turned side-to-side (their plane of rotation constantly changes) as they are moved around track 26 (FIG. 3B). Precession causes a force “downward” and outward in this case on each “half-wheel” (shown as arrows P). Since the “other half” of the wheel is missing, there is no counterbalancing or coupled force. The outward parts of the forces on all the wheels balance or cancel around the device, and the downward parts add to propel the device “downward” in this case. If the device were turned over, it would be propelled “upward”. This propelling force varies with the angular speed of the motor 10 and is smooth and continuous.

### Construction and Operation of Second Embodiment

In FIG. 4, construction is similar to that in the first embodiment except the wheels 24A roll around the inside of cone 14A. Precession is again downward and outward whether the motor 10A turns clockwise or counterclockwise. The path of each element 28A of the wheels 24A is a series of arcs bent around in a circle, but the apices of the arcs 30A face inward rather than outward (FIG. 4A). In this embodiment, centrifugal force pushes the arms 22A and wheels 24A toward cone 14A which tends to increase traction with motor speed.

### Construction of Third Embodiment

Construction is basically the same as in the first embodiment, except the wheels 24B do not roll against a surface, but spin in “mid-air”. In FIG. 5 a motor 10B is attached to a base plate 12B. A beveled ring gear 32 is attached to motor 10B or otherwise fixed in relation to base plate 12B. Substantially smaller pinion gears 34 (only two are shown) engage ring gear 32 and are attached solidly to arms 22B which rotate in bearings 36 in disc 18B. Disc is fixed to motor shaft 20B. Wheels 24B are attached solidly to arms 22B at their lower ends. Instead of wheels, hollow conical cylinders may be used, and are theoretically the most effective. Wheels 24B follow circular track 26B in operation. The ratio of track diameter to wheel diameter is substantially the same as the ratio of the diameter of large gear 32 to that of small gear 34, and can be any ratio, but the range of 2:1 to 8:1 is considered to be the most effective.

### Operation of Third Embodiment

Motor 10B is energized and rotates wheel-arm assembly around ring gear 32, causing wheels 24B to spin in “mid-air”, synchronized with the wheel-arm assembly at a simulated rolling rate. Each element of the wheels follows a series of arcs bent around in a circle and angled to it, upon which elements precession acts to drive the device forward (downward, in this case).

### Alternate Construction of Third Embodiment

Other ways of achieving the same result are:

1) To spin the wheels 24B with individual motors synchronized to the speed of the main motor. In this case, the main motor can be rotated either clockwise or counterclockwise with the wheels spinning in either direction.

2) To spin the wheels with magnets in the rim “dragged” by magnets in track. All means have the ratio of wheel diameter/track diameter=angular speed of main motor/angular speed of wheel.

### Construction of Fourth Embodiment

In FIG. 6 a motor 10C is attached to a pedestal 38 which is attached to base plate 12C. A “conical framework” 40 or cone of sheet metal or other material is attached to motor shaft 20C and bears on pedestal 38 at bottom. Weights 42 are fixed to solenoids 44 (shown), pneumatic cylinders, or other such devices, which in turn are attached to “conical framework” 40. Only two solenoids are shown but any number could be used that would fit. Slip rings provide electrical connections to solenoids.

### Operation of Fourth Embodiment

Motor 10C is energized and rotates “conical framework” 40 while solenoids 44 or cylinders move weights 42 up and down. In one rotation of framework 40 the weights move up and down a number of times, 2-6 being considered the most effective. The combination of motions produces a sinuous pathway for the weights which simulates “half-wheels” turning alternately clockwise and counterclockwise. (FIG. 6A) Precession acts on both to produce a force on each weight directed “upward” and outward. The net effect is a propelling force “upward”. If the device were turned over, the force would be “downward”.

### Alternate Construction of Fourth Embodiment

Weights may be placed on the ends of radially-placed arms which are cam-driven to move up and down as they are rotated in the larger circle.

### Construction of Fifth Embodiment

In FIG. 7, construction is similar to that of the fourth embodiment, but instead of solenoids 44 or other such devices, a sinuous closed tube 46 is attached closely to cone 14B. The loops 48 of the tube are substantially smaller in radius than the section of cone upon which they lie. One or more pumps 50 are placed in the tube circuit which is filled with liquid.

### Operation of Fifth Embodiment

Motor 10C is energized and rotates cone 14B as liquid is pumped around tube 46. The speed of the liquid in the tube is made to be approximately equal to the speed of the ends of the larger loops 48 as they travel with the cone. For example, if the speed of the cone at point A is 15 ft./sec., the speed of the liquid in the tube there is also about 15 ft./sec. The resulting path of each element of liquid in the tube is a series of arcs bent around in a circle, and precession drives the whole device in one direction. The direction of flow in the liquid is the same as the direction of travel of the cone, although it may be reversed and still work to some extent.

### DRAWINGS

FIG. 1A is a front view of the first embodiment.

FIG. 1B is a top view of the first embodiment.

FIG. 2A is a side view of a spinning wheel.

FIG. 2B is a top view (along arrow A) of a spinning wheel being turned right-to-left.

FIG. 2C is a front view (along arrow B) of a spinning wheel turning top-to-bottom.

FIG. 3A is a side view of the path of elements of a wheel rolling in a straight line.

FIG. 3B is a perspective view of the elements of a wheel rolling in a circle, and angled outward.

FIG. 4 is a side view of the second embodiment.

FIG. 4A is a top view of the path of an element of a rolling wheel in the second embodiment.

FIG. 5 is a side view of the third embodiment.

FIG. 6 is a side view of the fourth embodiment.

FIG. 6A is a perspective view of the path of a weight in the fourth embodiment.

FIG. 7 is a side view of the fifth embodiment.

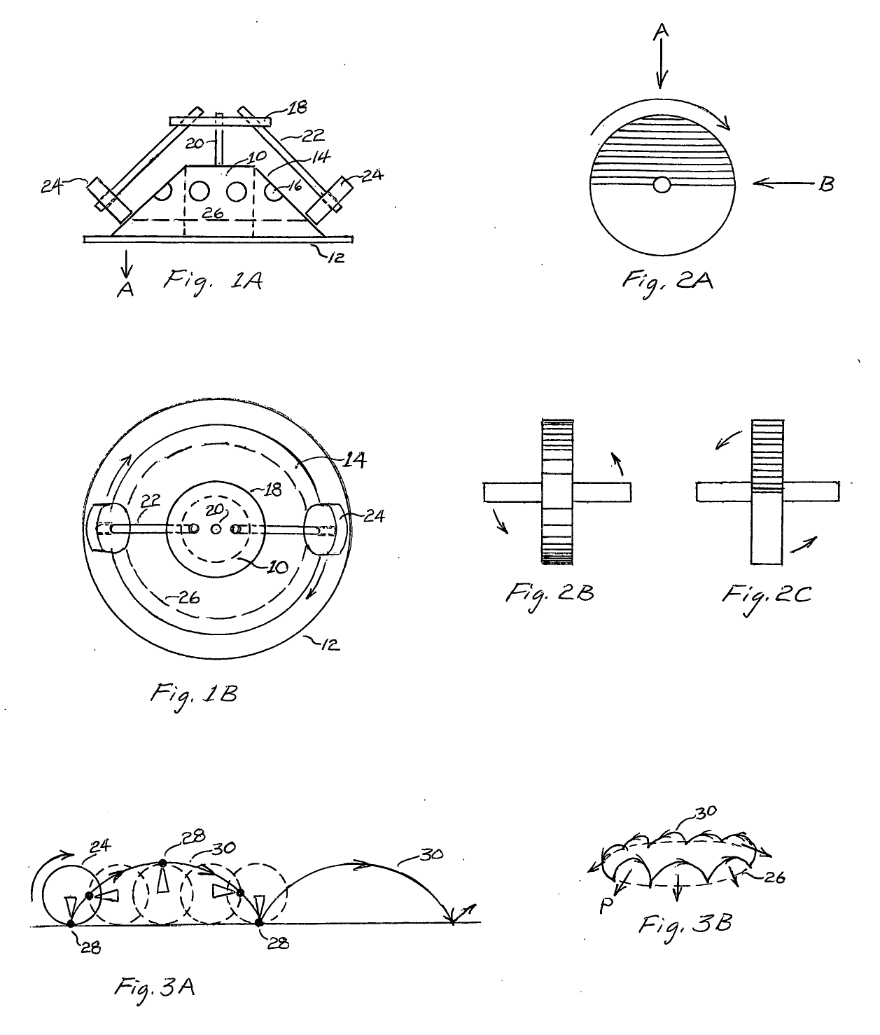

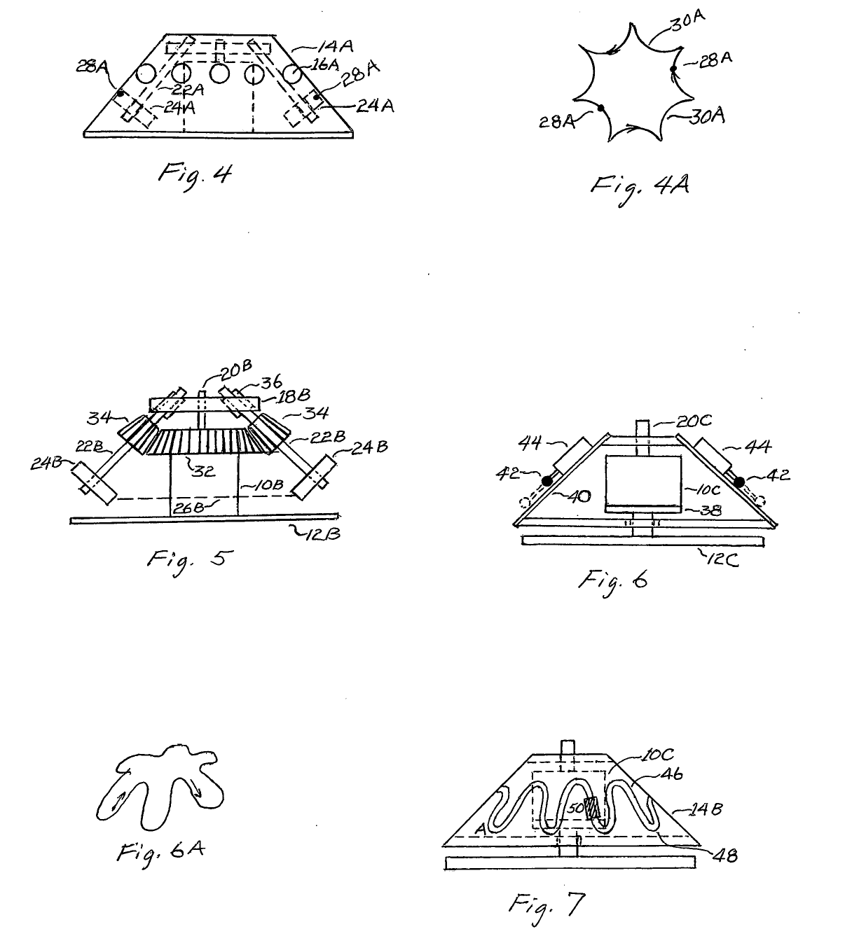

1. An inertially -driven device having elements of mass 28 made to move in a series of arcs 30 that follow a circle 26, with the planes of said arcs angled away from that of said circle and not perpendicular to it.
